(19) United States
(12) Patent Application Publication
(10) Pub. No.: US 2004/0035639 A1
(43) Pub. Date: Feb. 26, 2004

(54) Method and apparatus for fast removal, storing, and transporting of oil and lubricants from automotive and similar vehicles

(76) Inventor: Abdelkhalek Elhadiri, Orlando, FL (US)

Correspondence Address: ABDELKHAUEK ELHAOIRI, 5405 SAN GABRIEL WAY, ORLANDO, FL, 32837, US

(21) Appl. No.: 10/082,665

(22) Filed: Feb. 25, 2002

(51) Int. Cl. F16C 3/14

(52) U.S. Cl. 184/1.5

(57) ABSTRACT

An apparatus and method for removing of the oils and lubricants from an automobile or similar transportation vehicles employing the use of lubricant containers that have the means to determine fluid level by a dip stick type device. The apparatus provides a means of coupling to the vehicles dipstick tube through a flexible hose enabling quick removal of the fluids contained within the vehicle's reservoir. The fluid is transferred to a storage canister by means of the pressure differential created by a reversible positive displacement electrically driven pump with automatic shut off feature when the desired amount of fluid is removed or the reservoir is empty. The light-weight, modular construction enables ease of movement of the apparatus for storage and transport for disposable of the spent lubricants and oils in an environmentally safe and responsible manner. As a result, the apparatus provides the benefit of removing fluids from a vehicle in a rapid manner, and has the flexibility of unattended self-operation; thus overcoming the system shortcomings of manually operated vacuum pumps as well as the limitations for multiple usage's encountered with pre-charged vacuum systems.

### FEDERALLY SPONSORED RESEARCH

Not Applicable

### SEQUENCE LISTING OF PROGRAMS

Not Applicable

### BACKGROUND

1. Field of Invention

The present invention relates to an apparatus and method for rapid removal of fluids from automotive or similar vehicles and placing same within a container that can be held for temporary storage or transported to a fluid recycling station where the container is discharged of fluids. The device is intended but not limited to residential use, where the benefit is found of allowing the fluids to be removed from the vehicle without contact or exposures to persons or the environment.

2. Description of Prior Art

Removing lubricants and fluids from a vehicle in a residential location usually requires access to the underside of the vehicle, the use of tools for removal of drain plug or reservoir ports, and the use of a container to retain the lubricant removed from the vehicle. A review of the prior art shows that devices are available for exchanging and removing lubricants. However these devices require the creation of a pre-charged vacuum reservoir as the means of achieving a pressure differential for removing the lubricant (Goodman U.S. Pat. No. 5,772,402) or require the addition of permanent modifications to the vehicle by installed components (Morin U.S. Pat. No. 5,765,612). Other devices for changing lubricants that use pumping systems as the means of removing the lubricant are either bulky, and intended for stationary usage or are small and portable but require manual labor to generate the vacuum required to remove the lubricants. Several types of devices to remove lubricants have been proposed in the prior art in U.S. Pat. No. 4,807,674 (1989) by Sweet and U.S. Pat. No. 4,976,235 (1990) by Commanday as well as others. However, these devices are not portable, require manual labor as the means of generating pumping pressures, Be require permanent modifications to the vehicle, expose the lubricant to the user as well as the environment, cannot store more than one cycle of lubricant removal before disposal, and cannot operate unattended.

Objects and Advantages

Accordingly, several objects and advantages of the present invention are:

(a) to provide a portable apparatus for removal of lubricants and fluids from automotive or similar vehicles.

(b) to provide a portable apparatus with integral reversible fluid pump powered by an electrical driven motor

(c) to provide a portable apparatus that enables lubricant removal through the access port of the vehicle such as the “dip-stick” tube.

(d) to provide a portable apparatus that does not require permanent modifications or addition of components to the vehicle.

(e) to provide a portable apparatus with a container that can hold a quantity of fluid greater than that created by removing all the lubricant from the vehicle reservoir.

(f) to provide a portable apparatus that can operate unattended.

(g) to provide a portable apparatus that prevents exposure of the lubricant to environment or persons

It is the principal object of the present invention to provide an apparatus and method of operation that enables the rapid removal of fluids from vehicles without exposing the user to the lubricants, drivetrain fluids or require the presence of the user during removal as the apparatus is equipped with a self-shutoff feature.

It is also an object of the present invention to provide an apparatus that enables the temporary storage of drivetrain fluids prior to appropriate disposal.

It is an object of the present invention to make said apparatus portable, having ease of movement, positioning and transportation.

It is also an object of this invention to provide an apparatus that offers value, utility and ease of use to the person or persons desiring to remove fluids from a vehicle.

### SUMMARY

In accordance with the present invention an apparatus and method for rapid removal of fluids from automotive or similar vehicles and placing same within a container that can be held for temporary storage or transported to a fluid recycling station where the container is discharged of fluids. The device in this specification enhances mobility, reduces cost of operation, protects the environment from oil spillage, the present invention enhances utility by been self sealing, low weight, easy to handle and eliminating the exposure of the fluids to person or persons.

As an apparatus intended for residential use the device has enhanced ease of operation and use. By extracting the fluids from above the vehicle through the dipstick tube or similar reservoir fill orifices the need to crawl beneath the vehicle, removing the drain plug, and placing a suitable storage device beneath the vehicle to capture the fluid is eliminated. The present invention offers the additional advantage of having a container sized to allow more than one fluid removal cycle prior to encountering the need to transport the apparatus to a disposal site for fluid removal. During transport, the present invention enhances utility by been self sealing, low weight, easy to handle and eliminating the exposure of the fluids to person or persons.

The incorporation of electrical power to operate the pumping system of the present invention also enhances its utility and facilitates its use by the user by eliminating the manual exertion required by several of the vacuum pumps described in previous patents or commonly found in the market place. The use of fluid level feed back to enable unattended operation also enhances utility as well as provides the benefits of reducing costs by enabling its use during time periods when power rates are lower such as night time.

The other devices disclosed within the prior art where found to have the following limitations. Require manual labor for operation, require semi permanent modifications to the vehicle, limit the mobility or transport of the device, or are limited to single use.

The present invention eliminates each of these limitations thus proving useful and beneficial beyond the known prior art.

Essentially the apparatus of this invention enables the user to couple the device to the fluid reservoir of a vehicle an extract the fluids contained herein without having to be present during the operation of the device. The self-sealing nature of the ports within the fluid storage container of the apparatus enables the removal of fluids from the vehicle without spillage or exposure of the operator to said fluids. As well as preventing exposure of said fluids to the environment during storage.

An important feature of the invention is the incorporation of an electrically driven fluid pump. The pump when coupled with the feedback sensors and shut off switches enables an unattended operation thus enhancing the productivity of the user. This feature also provides the benefit of eliminating the exertion of manual labor to provide the pumping forces.

The apparatus is self contained and ready for use when positioned near a vehicle thus enabling the user to rapidly removed the selected fluids from the vehicle without requiring additional tools or modifications to the vehicle.

### DRAWINGGS

Drawing Figures

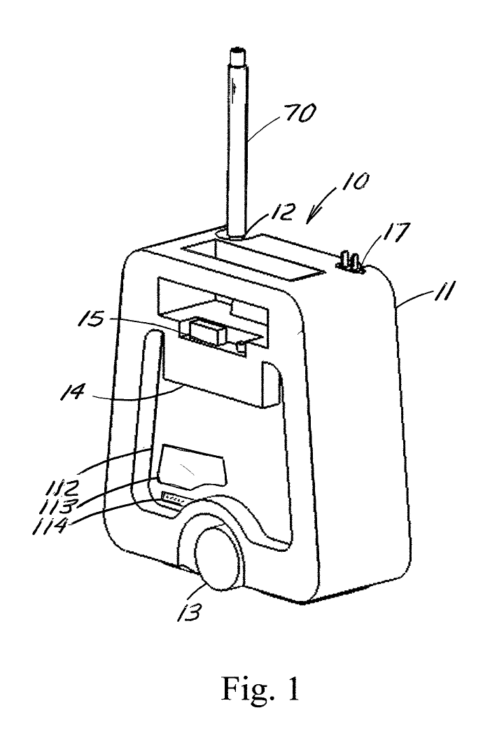

FIG. 1 is an front right top perspective view of the invention showing container fill hose, outlet port, pump position and controls.

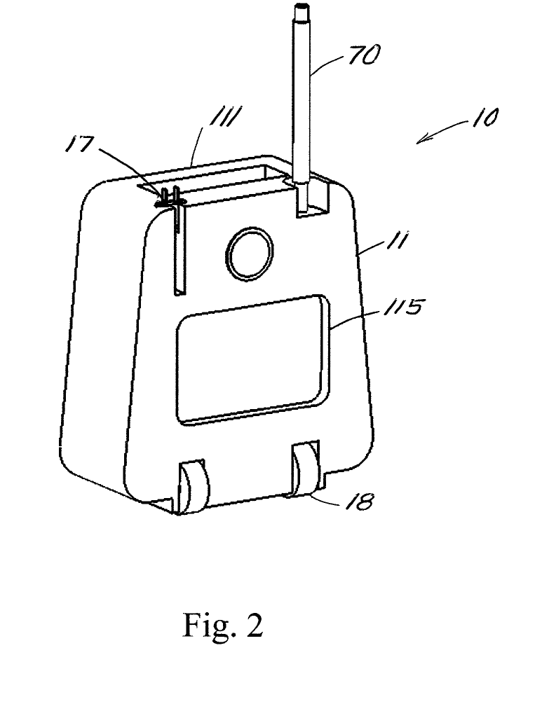

FIG. 2 is a back right top perspective view of the invention showing container, with mobility wheels, hose storage compartment, and power cord.

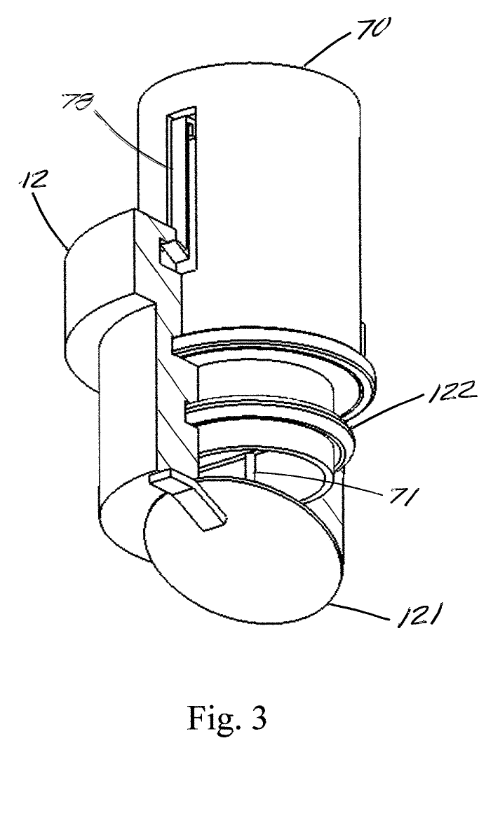

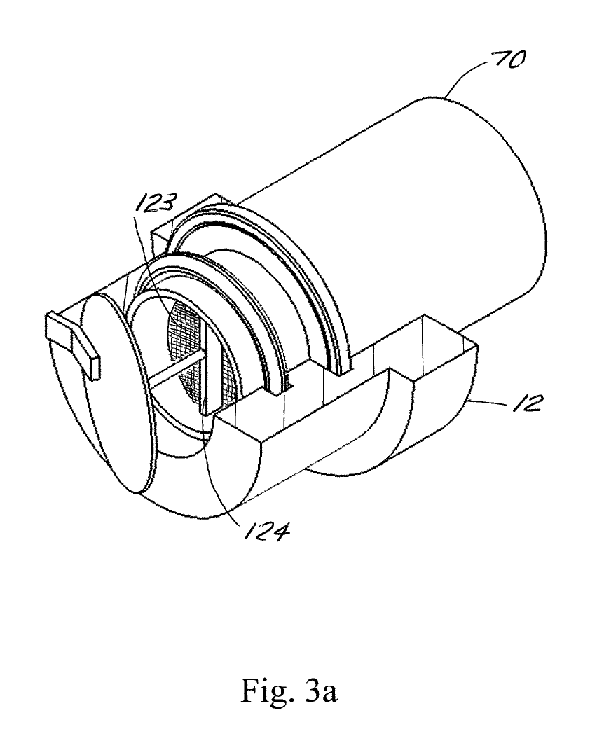

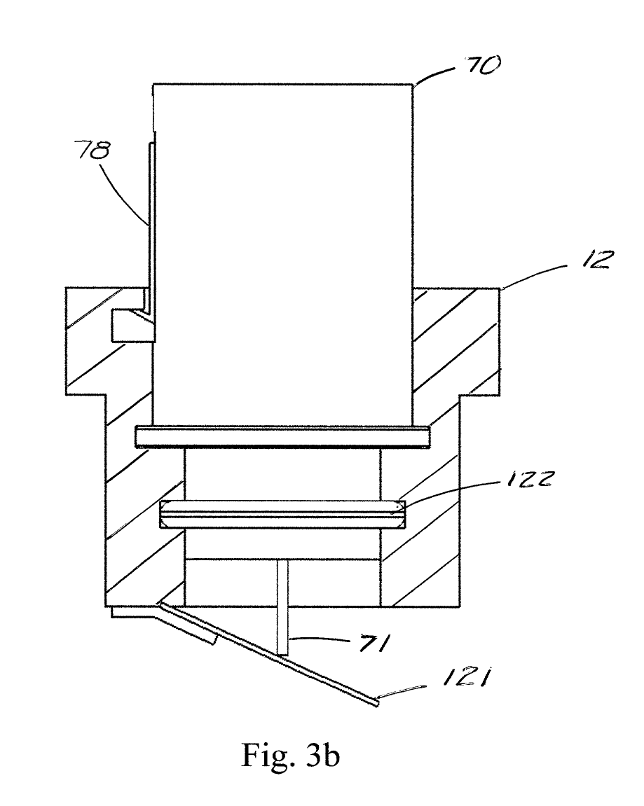

FIG. 3 shows the preferred embodiment of the inlet/outlet seal and flow control valve.

FIG. 3a shows the filter screen and bar magnet.

FIG. 3b shows the retainer clip in the engage position at the inlet port.

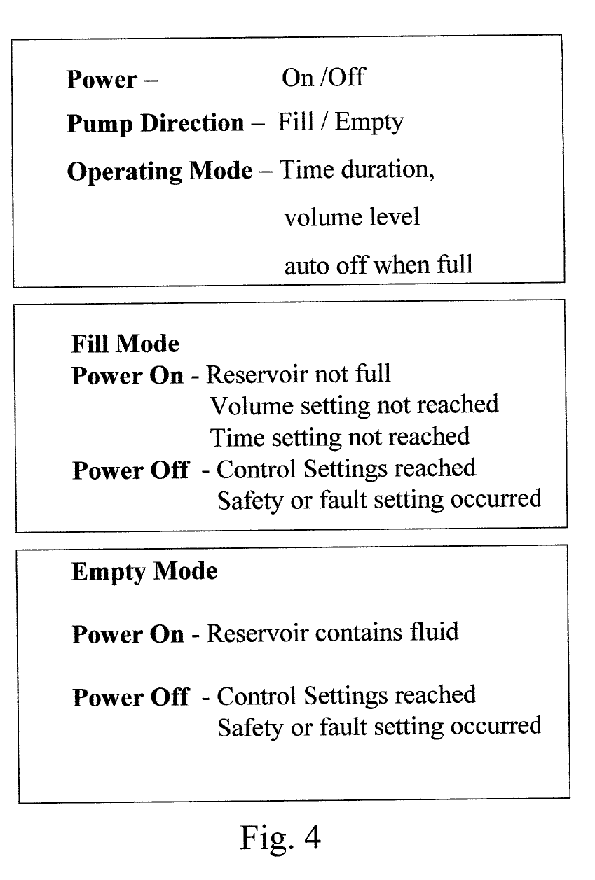

FIG. 4 shows the graphical representation of the functional block diagram for the system operation and controls.

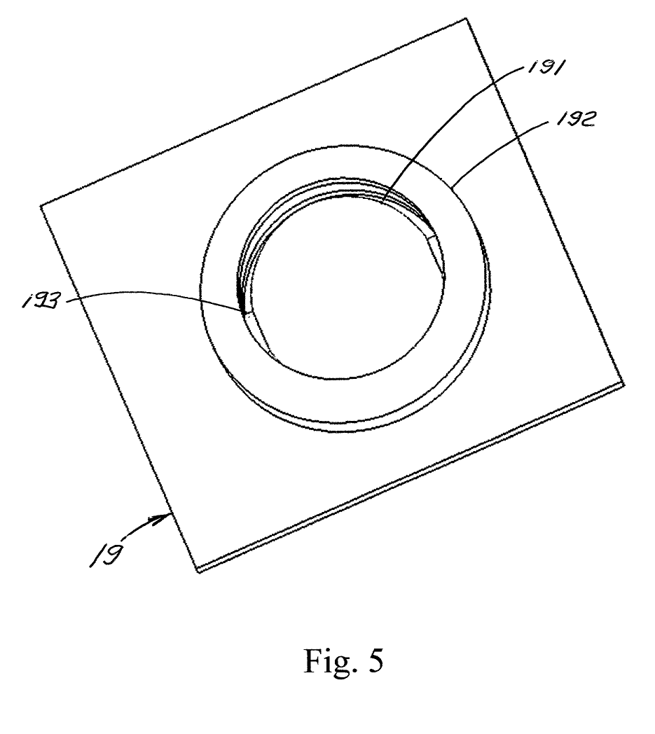

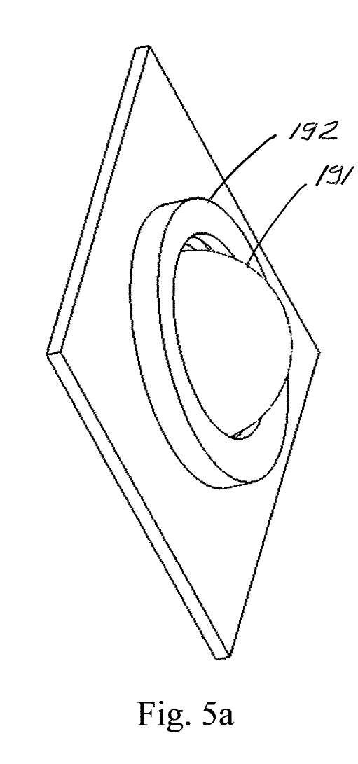

FIG. 5 shows the preferred embodiment for the steering or guide wheel and the glide Ills rollers

FIG. 5b shows the steering wheel and retainer ring.

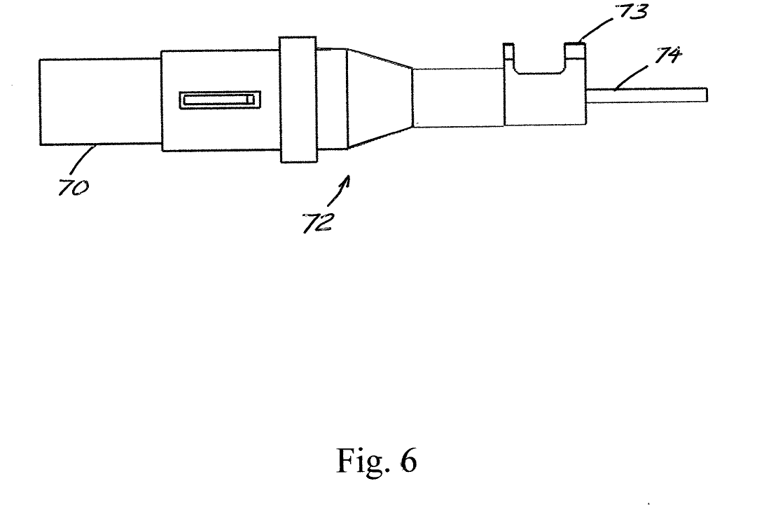

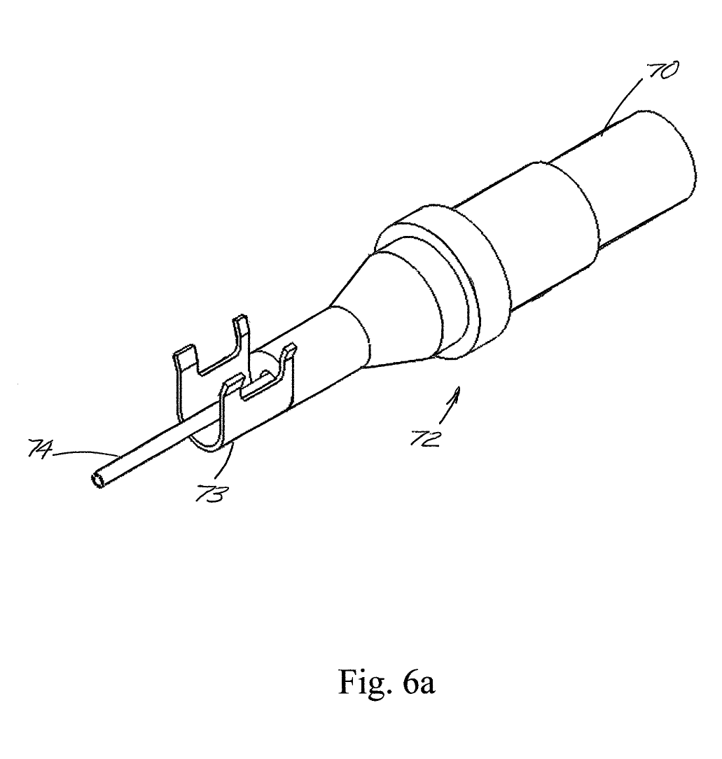

FIG. 6 shows the preferred embodiment for the distal end of the fill hose, including retainer and seal actuator.

FIG. 6a shows distal end of the fill hose with retainer.

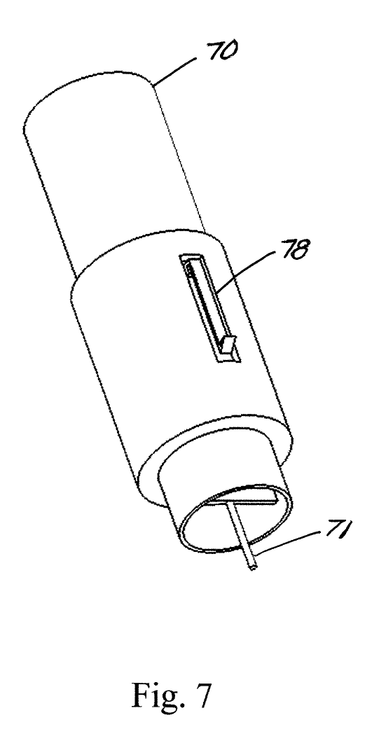

FIG. 7 shows the preferred embodiment of the proximal end of the fill hose including actuator for the flow control valve.

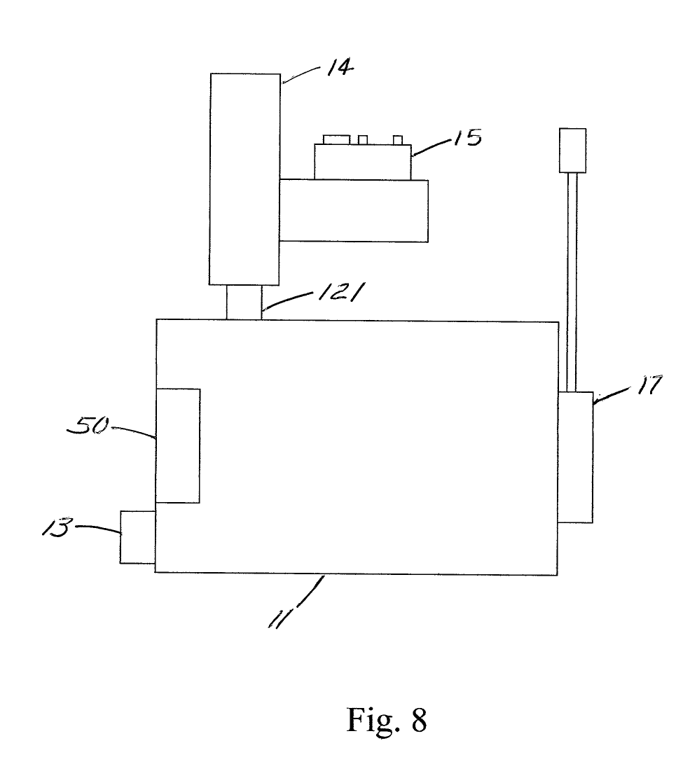

FIG. 8 shows the block diagram of the components within the container the pump, control system and power cord retractor.

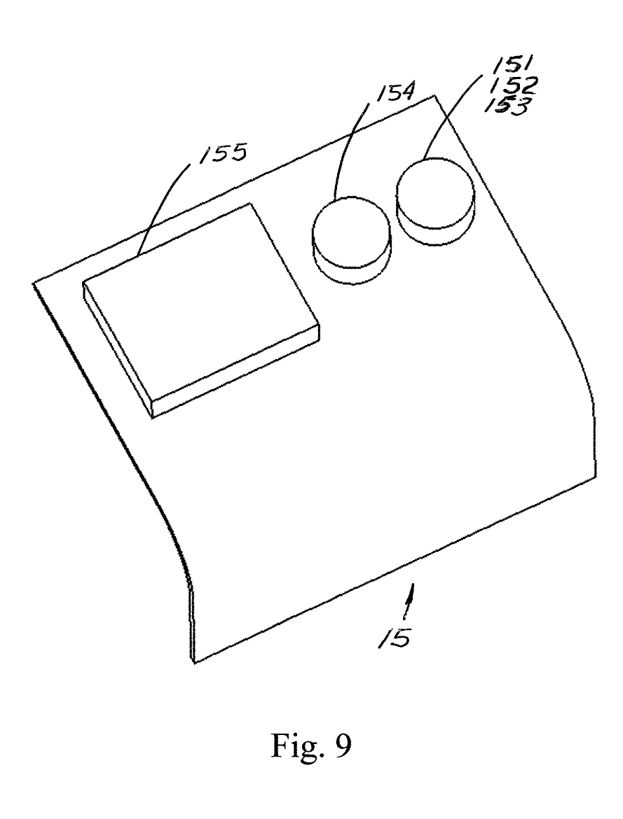

FIG. 9 shows the preferred embodiment of the control panel switches

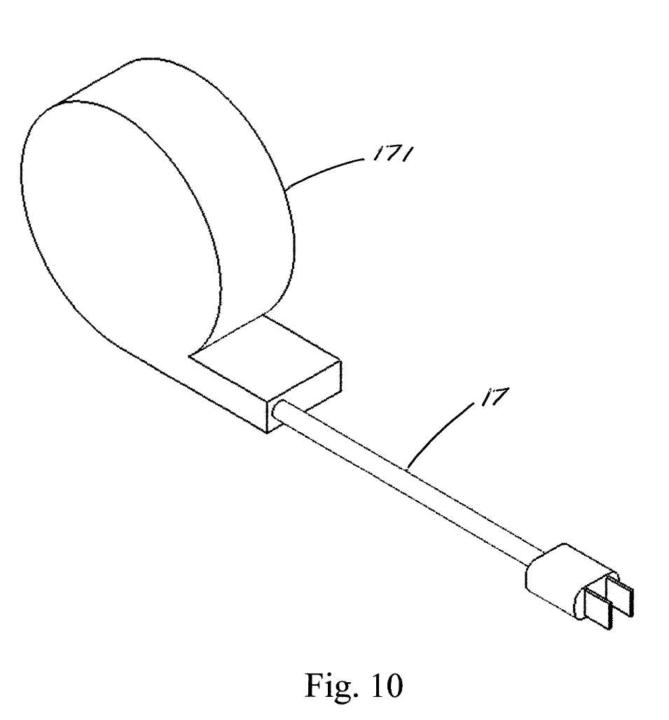

FIG. 10 shows the preferred embodiment of the power cord retractor spring arrangement

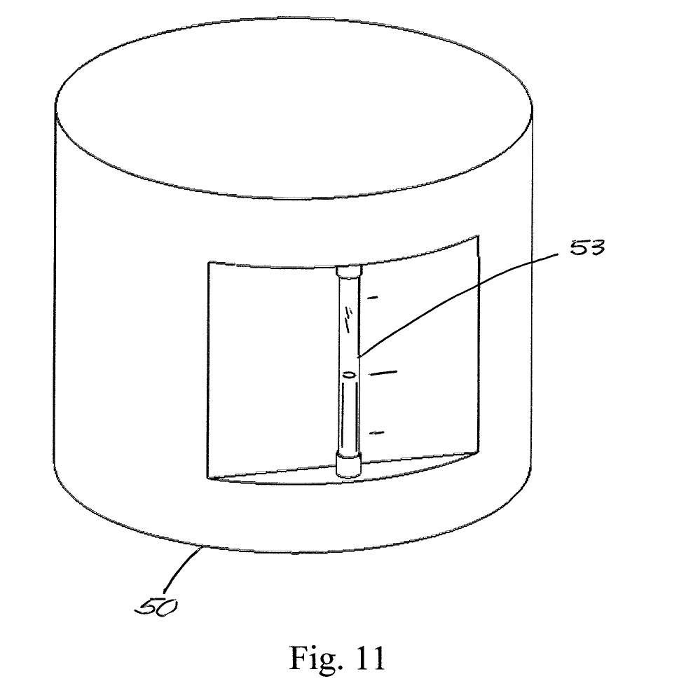

FIG. 11 shows the preferred embodiment of the level sensor.

### DESCRIPTION OF THE PREFERRED EMBODIMENT

Referring to the drawings, FIG. 1 shows the preferred embodiment of the rapid fluid removal apparatus of this invention designated by the reference numeral 10.

The fluid container 11, is shown in the preferred embodiment configuration consisting of a plastic molded container featuring a fill port 12, outlet port 13, pump enclosure 14, and control panel 15. Alternatively the fluid container 11 can be constructed from welded metal sheets made of such corrosive resistant materials as titanium and stainless steel. The container 11 includes an integral handle 111, a depression on the surface 112 that serves as a component retention area while working on the vehicle as well as a locator for cosmetic label 113 and serial number identifier 114. During use, the proximal end of the fill hose 70 is attached to the fill port 12 and retained in place by clip 78 as shown in FIG. 3. This action causes the valve actuator 71 located at the proximal end of the fill hose 70 to open the flow control valve 121 located in the fill port 12. The fill port 12 also features an integral seal 122 which seals against fluid spillage against the valve actuator 71 feature of the fill hose 70. The outlet port 13 is comprised of the same components and functional nature as the inlet port 12. The Flow control valve 121 and the seal 122 of the outlet port 13 are identical to the components of the inlet port 12 therefore, the same numerical identifiers are used.

With the rapid fluid removal apparatus 10 located near a vehicle, the distal end 72 of the fill hose 70, as shown in FIG. 6, is connected to the dipstick tube of the vehicle.

The distal end 72 has a retainer 73 with an extension tube 74, which is inserted into the dipstick tube and extended, into the fluid reservoir of the vehicle. With the power cord 17 connected to a standard electrical outlet the apparatus 10 is ready for operation.

To operate the rapid fluid removal apparatus 10, the operating mode switch 151 located on the control panel 15 as shown in FIG. 9 is set to the desire position “Container Fill” 152 or “Container Empty” 153. Then the control mode switch 154 is set to the desired fluid level capacity. To initiate operation of the apparatus 10, the power switch 155 is set to the on position. This activates the power pump 14 creating a pressure difference within the container and atmosphere that causes the fluid in the vehicle to flow into the container 11. The apparatus 10 is equipped with a resistance level sensor 50 that senses the level of the fluid within container 11 as a function in change of resistance. When the container is full an electrical switch closes stopping the operation of pump 14. The pump 14 also stops upon reaching the fluid level set by the control mode switch 154 or by a time period passing without change in reading from the level sensor 50. These features enable the apparatus 10 to operate unattended. In FIG. 2 the apparatus 10 shows the mobility wheels 18 which are engaged when the device is tilted from a horizontal angle beyond 30 degrees. This is easily accomplished by lifting the device-using handle 111. In this position the apparatus 10 is easily transported. The container 11 is provided with a holder 115 for storage of the fill hose 70 when it is not in use. The steering wheel 19 as shown in detail within FIG. 5 provides ease of directional control and movement when the device is place on a horizontal plane. The steering wheel 19 consists of a tracking ball 191, retainer ring 192 and glide rollers 193. The function of the steering wheel is to provide ease of relocation and positioning in any direction over a 360-degree plane. The power cord 17 is located in a depression within container 11 as shown in FIG. 2. The power cord has a retracting feature 171 Enabling auto retraction of the power cord 17. The preferred embodiment for the power cord-retracting feature 171 is a constant force spring.

FIG. 3 shows the preferred embodiment for the inlet port 12, which includes a filter screen 123 and a bar magnet 124. The filter screen 123 is a metallic 75 percent occluded knit mesh made of stainless steel. Filter screen 123 is retained within the inlet port 12 by a bar magnet 124. The assembly of the inlet port 12 and outlet port 13 are identical except that the outlet port 13 is configured without filter screen 123 or bar magnet 124. The purpose of the filter screen 123 is to prevent metallic components carried by the fluids from entering into the container 11. The bar magnet 124 aids in this function. The benefit of having these components as part of the inlet port 12 is that the container 11 and its related components are kept clear of debris.

The general operation of the apparatus 10 is shown in a graphical representation within FIG. 4. The control scheme for the container fill mode is shown in block 41 with the control-input conditions shown in block 40 and the control scheme for the container empty mode is shown in block 42.

In this invention the container 11 has several internal features as shown in FIG. 8. The general arrangement of the container 11 and internal connections for the pump 14, control system 15 and power CORD retractor 171 are included in this figure. The main advantage to this configuration is the modular nature of the component arrangements as well as the reduction in cost and ease of service of for the functional components.

FIG. 11 Shows the preferred embodiment of the level sensor 50 and site tube 53 which of a hollow clear cylinder with graduated markings.

As an alternate embodiment the level sensor can be comprised of reed switches or similar transducer which sense the fluid level within the container 11. Although the preferred embodiment of the invention has been specifically illustrated and described herein, it is understood that minor variations such as color changes, material specifications, and substitutions of similarly functioning components such as replacement of the screen filters with barrier filters may be made to the apparatus without departing from the spirit and scope of the invention.

What is claimed is:

1. An apparatus and method for rapid removal of fluids contained within reservoirs in automotive or similar transportation vehicles comprising:
a) flexible hose and means of attachment of the distal end of said hose to the vehicle's dipstick tube or similar access point to the fluid reservoirs within the vehicle and
b) flexible hose with flow directional valve at proximal end with coupling suitable for attachment to the fill port of the storage canister and
c) storage canister suitable to hold fluids of various viscosities' and corrosive characteristics such as oils, lubricants, cleaning agents, and coolants used within the vehicle.

2. The storage container as claimed in claim 1 having a volume usable for storage of more than one vehicle oil change further comprising:
a) fluid pump powered by electric motor and
b) retractable power cord.

3. The apparatus of claim 1 wherein said container includes a screen filter and magnetic separator to capture metallic debris and solid contaminants

4. The apparatus of claim 1 wherein said container includes inlet and outlet ports with integral seal and quick release hose attachment with spill proof check valve.

5. The apparatus of claim 1 wherein said container is provided with wheel to enable ease of positioning and movement.

6. The apparatus of claim 5 wherein said positioning wheel is comprised in the preferred embodiment of a captured ball that facilitates steering through 360 degrees of directional change.

7. The apparatus of claim 3 where said outlet and inlet ports include an integral molded in place seal similar to an o-ring and contain a molded in place flow control valve comprised in the preferred embodiment of a reed/slit valve.

8. The apparatus of claim 1 wherein said container is fabricated as a one piece molding made from a plastic such as polypropylene or as a weldment assembly of metallic components made from corrosion resistant metals such as 316L Stainless Steel or Titanium.

9. The apparatus of claim 1 wherein said container is provided with the means of determining fluid level by employing transparent plastics, or incorporation of a fluid level gauge.

10. The apparatus of claim 9 wherein said fluid level gauge is comprised in the preferred embodiment of a graduated flexible clear tube.

11. The apparatus of claim 1 wherein said container is provided with a handle that enables lifting the device, as well as transporting the device by tilting the device to an angle upon which the transport wheels are engaged to freely rotate.

12. The apparatus of claim 1 wherein said container is provided with a self-retracting power cord.

13. The apparatus of claim 12 wherein said power cord is comprised within the preferred embodiment of a flexible cable enclosing electrical conductors incorporating a constant force spring spool enabling ease of extraction and retraction.

14. The apparatus of claim 1 wherein said fluid pump is comprised within the preferred embodiment as a positive displacement vane pump with reversible electric motor thus enabling pressure filling and pressure discharge of the fluids within the container.

15. The apparatus within claim 1 wherein the method for rapid removal of fluids from a vehicle is comprised:
a) placement of the apparatus within a proximal distance of the vehicle and,
b) connection of the fill flexible hose to the inlet port of the container and,
c) connection of the power cord to an active electrical outlet.
